(19) United States
(12) Patent Application Publication
(10) Pub. No.: US 2018/0073405 A1
(43) Pub. Date: Mar. 15, 2018

(54) GASOLINE PARTICULATE FILTER AND EXHAUST SYSTEM HAVING THE SAME

(71) Applicant: Hyundai Motor Company, Seoul (KR)

(72) Inventor: Chun Yong KANG, Yongin-si (KR)

(73) Assignee: Hyundai Motor Company, Seoul (KR)

(21) Appl. No.: 15/372,189

(22) Filed: Dec. 7, 2016

(30) Foreign Application Priority Data
Sep. 9, 2016 (KR) 10-2016-0116714

(51) Int. Cl. F01N 3/022; B01D 46/24; B01D 39/20

(52) U.S. Cl. CPC F01N 3/0222; B01D 46/2403; F01N 2330/34; B01D 2279/30; B01D 2239/0407; B01D 39/2068

(57) ABSTRACT

A gasoline particulate filter may include at least one inlet channel extending in a longitudinal direction, and having a first end portion into which fluid flows and a second end portion which is blocked; at least one outlet channel extending in a longitudinal direction, and having a first end portion which is blocked and a second end portion through which the fluid flows out; at least one flow channel formed between the inlet channel and the outlet channel, and extending in a longitudinal direction in which fluid flows; at least one porous wall that defines the boundary between adjacent inlet and outlet channels and that extends in a longitudinal direction; and at least one partition protruding from the porous wall.

### CROSS-REFERENCE TO RELATED APPLICATION

The present application claims priority to Korean Patent Application No. 10-2016-0116714 filed on Sep. 9, 2016, the entire contents of which is incorporated herein for all purposes by this reference.

### BACKGROUND OF THE INVENTION

### Field of the Invention

The present invention relates to a gasoline particulate filter and exhaust system having the same. More particularly, the present invention relates to a gasoline particulate filter having a muffler function and exhaust system having the same.

### Description of Related Art

Gasoline vehicles recently developed apply engine downsizing, turbo supercharger and gasoline direct injection (GDI) system to obtain high power by a little fuel. However, in the gasoline direct injection system, fuel is injected by high pressure to form fuel liquid film on the wall surface in the combustion room and the upper part of a piston and combust incompletely by non-uniform mixture of air and fuel, therefore particulate matter that is higher level than diesel vehicles is exhausted.

This particulate matter penetrates into the human body through the respiratory organs to occur inflammation such as bronchial trouble and emphysema of the lungs. Also, the particulate matter includes a carcinogenic substance. Therefore, regulation of exhaust gas amount for diesel vehicles is generated from Euro5 which is Europe vehicle exhaust gas regulation, and regulation of exhaust gas amount (6×10¹¹ N/km) for gasoline vehicles is started from Euro6-c which is expected to implement from September, 2017. Accordingly, conventional gasoline direct injection vehicles exhaust particulate matter that does not satisfy the regulation of Euro6-c, so install of gasoline particulate filter (GPF) is examined.

The gasoline particulate filter uses wall flow method that is same with diesel particulate filter (DPF) and flow through method to eliminate particulate matter, and coats three way chatalyst (TWC) on or in a carrier to purify exhaust gas exhausted from an engine. Also, high temperature and high pressure exhaust gas abruptly expands in a muffler during being released to atmosphere to generate noise. The muffler expands the exhaust gas step by step or interferes pressure wave repeatedly to drop pressure and temperature, so noise generated by releasing exhaust gas is reduced.

Location that the gasoline particulate filter is installed is between a catalyst and a center muffler in the conventional exhaust layout or at side of the center muffler in case front-engine, rear-wheel drive vehicles. Therefore, it is inevitable to increase cost of vehicles by changing conventional exhaust system and installing gasoline particulate filter. Accordingly, it is necessary to minimize cost increase owing to installing gasoline particulate filter.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a gasoline particulate filter having silencer function of muffler and exhaust system having the same.

A gasoline particulate filter according to an exemplary embodiment of the present invention includes at least one inlet channel extending in a longitudinal direction, and having one end portion into which fluid flows and the other end portion which is blocked; at least one outlet channel extending in the longitudinal direction, and having one end portion which is blocked and the other end portion through which the fluid flows out; at least one flow channel formed between the inlet channel and the outlet channel, and extending in a longitudinal direction in which fluid flows; at least one porous wall that defines the boundary between adjacent inlet and outlet channels and that extends in the longitudinal direction; and at least one partition protruding from the porous wall.

Cross section of the inlet channel and the outlet channel may be polygon shape.

Cross section of the inlet channel and the outlet channel may be formed as one of hexagonal to dodecagonal shape.

Diameter of the cross section of the inlet channel may become smaller as the inlet channel becomes close to the flow channel.

Diameter of the cross section of the outlet channel may become bigger as the outlet channel becomes far from the flow channel.

The partition may be formed same with cross section shape of the inlet channel and the outlet channel.

The shape of the inlet channel, outlet channel and flow channel may be formed by using 3 dimension printing method.

The porous wall may be formed by forming pores through adding organic or inorganic additives to ceramic or raw material and heat treatment.

Size of the pores may be settled by kinds of additives.

The pores may be formed as various sizes through non-uniform sedimentation of soot and ash according to location of the porous wall.

According to an exemplary embodiment of the present invention, shape of the inlet channel, outlet channel and flow channel of the gasoline particulate filter is optimized to control back pressure and sound characteristics. Therefore, back pressure may be reduced and filtering performance may be improved.

Also, cost may be reduced by adding muffler function to conventional gasoline particulate filter.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic drawing of particulate matter filtering system which a gasoline particulate filter according to an exemplary embodiment of the present invention is mounted.

FIG. 2 is a schematic cross-sectional view of a gasoline particulate filter according to an exemplary embodiment of the present invention.

FIG. 3 is a schematic front view of a gasoline particulate filter according to an exemplary embodiment of the present invention.

FIG. 4 is a schematic front view of a gasoline particulate filter according to other exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Exemplary embodiments of the present application will be described more fully hereinafter with reference to the accompanying drawings, in which exemplary embodiments of the invention are shown. As those skilled in the art would realize, the described embodiments may be modified in various different ways, all without departing from the spirit or scope of the present invention.

Further, in exemplary embodiments, since like reference numerals designate like elements having the same configuration, various exemplary embodiments is representatively described, and in other exemplary embodiments, only configurations different from the various exemplary embodiments will be described.

The drawings are schematic, and are not illustrated in accordance with a scale. Relative dimensions and ratios of portions in the drawings are illustrated to be exaggerated or reduced in size for clarity and convenience, and the dimensions are just exemplified and are not limiting. In addition, like structures, elements, or components illustrated in two or more drawings use like reference numerals for showing similar features. It will be understood that when an element including a layer, film, region, or substrate is referred to as being “on” another element, it can be directly on the other element or intervening elements may also be present.

The exemplary embodiment of the present invention shows an exemplary embodiment of the present invention in detail. As a result, various modifications of the drawings will be expected. Therefore, the exemplary embodiment is not limited to a specific aspect of the illustrated region, and for example, includes modifications of an aspect by manufacturing.

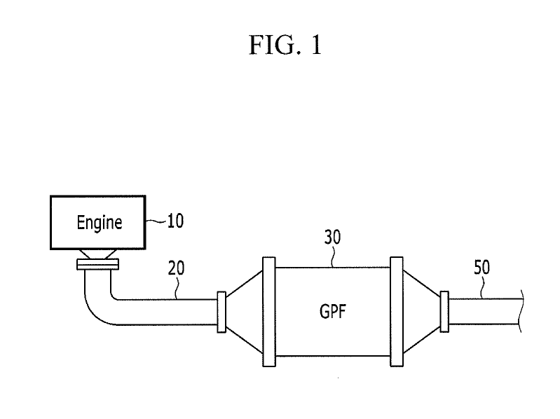

Now, a gasoline particulate filter according to an exemplary embodiment of the present invention will be described with reference to FIG. 1 to FIG. 4.

FIG. 1 is a schematic drawing of particulate matter filtering system which a gasoline particulate filter according to an exemplary embodiment of the present invention is mounted.

As shown in FIG. 1, a particulate matter filtering system including a gasoline particulate filter 30 has a structure that the gasoline particulate filter 30 is mounted between a front exhaust pipe 20 and a rear exhaust pipe 50. Exhaust gas exhausted from an engine 10 enters the gasoline particulate filter 30 through the front exhaust pipe 20, and the gasoline particulate filter 30 filters the exhaust gas. Next, the filtered exhaust gas is exhausted to atmosphere through the rear exhaust pipe 50.

The gasoline particulate filter 30 is connected to a control unit, and the control device controls operation of the particulate matter filtering system.

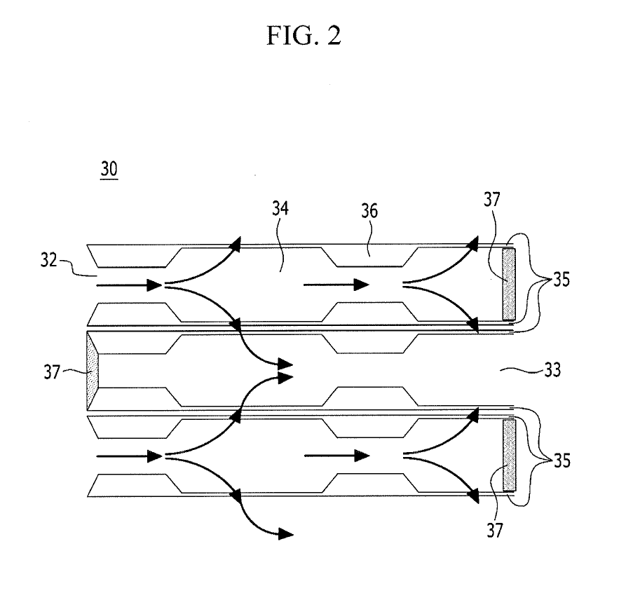

FIG. 2 is a schematic cross-sectional view of a gasoline particulate filter according to an exemplary embodiment of the present invention.

As shown in FIG. 2, the gasoline particulate filter 30 according to an exemplary embodiment of the present invention includes at least one inlet channel 32 and at least one outlet channel 33 in a housing. The inlet channel 32 extends in a longitudinal direction, and includes one end portion into which fluid flows and the other end portion which is blocked, and the outlet channel 33 extends in the longitudinal direction, and includes one end portion which is blocked and the other end portion through which the fluid flows out. The other end portion of the inlet channel 32 and the one end portion of the outlet channel 33 which are blocked are formed as a plug 37.

Also, at least one flow channel formed between the inlet channel 32 and the outlet channel 33, and extending in a longitudinal direction in which fluid flows. A plurality of the inlet channel 32 and the outlet channel 33 are divided by the wall 35.

The inlet channel 32 extends along a flow of the exhaust gas. A front end portion of the inlet channel 32 is open so that the exhaust gas is introduced into the gasoline particulate filter 30 through the inlet channel 32. A rear end portion of the inlet channel 32 is blocked by a plug 37. Therefore, the exhaust gas in the gasoline particulate filter 30 cannot flow out of the gasoline particulate filter 30 through the inlet channel 32.

The outlet channel 33 extends along the flow of the exhaust gas and may be placed parallel to the inlet channel 32. At least one inlet channel 32 is located around the outlet channel 33. Since a front end portion of the outlet channel 33 is blocked by the plug 37, the exhaust gas cannot flow into the gasoline particulate filter 30 through the outlet channel 33. A rear end portion of the outlet channel 33 is open so that the exhaust gas in the gasoline particulate filter 30 flows out of the gasoline particulate filter 30 through the outlet channel 33.

A wall 35 is placed between adjacent inlet and outlet channels 32 and 33 to define the boundary between them. The wall 35 may be a porous wall 35 with at least one micropore in it. The porous wall 35 allows the neighboring inlet and outlet channels 32 and 33 to fluidically-communicate with each other. Thus, the exhaust gas introduced into the inlet channel 32 may move to the outlet channel 33 through the porous wall 35. Moreover, the porous wall 35 prevents particulate matter in the exhaust gas from passing therethrough. When the exhaust gas moves from the inlet channel 32 to the outlet channel 33 through the porous wall 35, the particulate matter in the exhaust gas is filtered through the porous wall 35. The porous wall 35 may be made from aluminum titanate, codierite, silicon carbide, etc.

The gasoline particulate filter 30 according to an exemplary embodiment of the present invention includes at least one partition protruding from the porous wall 35. The partition may be formed same with cross section shape of the inlet channel 32 and the outlet channel 33.

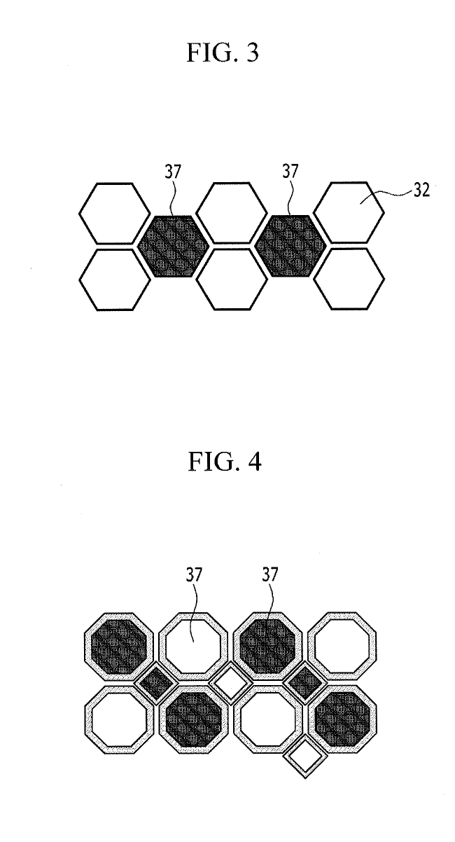

FIG. 3 is a schematic front view of a gasoline particulate filter according to an exemplary embodiment of the present invention, and FIG. 4 is a schematic front view of a gasoline particulate filter according to other exemplary embodiment of the present invention.

As illustrated in FIG. 3 and as shown in FIG. 4, cross section of the inlet channel 32 and the outlet channel 33 may be polygon shape close to circle shape, and may be formed as one of hexagonal to dodecagonal shape. The flow channel has to be formed narrowly to improve filtering performance of the particulate matter, however in the instant case, back pressure increases to decrease the engine 10 power and deteriorate fuel efficiency. On the contrary to this, when the flow channel 34 is wide, filtering performance decreases. Accordingly, entrance cross section shape of the inlet channel 32 and the outlet channel 33 is formed as polygon shape close to circle shape, and diameter of the inlet channel 32 becomes smaller to contact point with the flow channel 34. On the contrary to this, diameter of the outlet channel 33 becomes bigger as the outlet channel 33 becomes far from the flow channel 34.

The shape of the inlet channel 32, outlet channel 33 and flow channel 34 may be formed by using 3 dimension printing method. Since changing of diameter and width of the inside flow channel 34 is difficult by conventional extruding method, 3 dimension printing method which is possible to make 3 dimension structure having various size and complicated shape may be used. The 3 dimension printing method may be conducted by using various materials including metal, plastic and ceramic etc.

Meanwhile, the porous wall 35 may be formed by forming pores through adding organic or inorganic additives to ceramic or raw material and heat treatment. In a process of heat treatment of the ceramic or raw material in which organic or inorganic additives are added, the pores are generated by volatilization and combustion of the additives. The size of the pores depend on the additives, and may be controlled to be micrometers (μm) to hundreds of micrometers according to kinds of the additives. The pores may be formed as various sizes through non-uniform sedimentation of soot and ash according to location of the porous wall. Uniform sedimentation rather increases back pressure, therefore non-uniform sediment is effective to decrease back pressure.

Like this, according to an exemplary embodiment of the present invention, shape of the inlet channel, outlet channel and flow channel of the gasoline particulate filter is optimized to control back pressure and sound characteristics. Therefore, back pressure may be reduced and filtering performance may be improved.

Also, cost may be reduced by adding muffler function to conventional gasoline particulate filter.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “interior”, “exterior”, “inner”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A gasoline particulate filter, comprising:
at least one inlet channel extending in a longitudinal direction thereof, and having a first end portion into which fluid flows and a second end portion which is blocked;
at least one outlet channel extending in a longitudinal direction thereof, and having a first end portion which is blocked and a second end portion through which the fluid flows out;
at least one flow channel formed between the at least one inlet channel and the at least one outlet channel, and extending in a longitudinal direction thereof, in which fluid flows;
at least one porous wall that defines a boundary between adjacent inlet and at least one outlet channels and that extends in a longitudinal direction thereof; and
at least one partition protruding from the at least one porous wall.

2. The gasoline particulate filter of claim 1, wherein cross section of the at least one inlet channel and the at least one outlet channel is polygon shape.

3. The gasoline particulate filter of claim 1, wherein cross section of the at least one inlet channel and the at least one outlet channel is formed as one of hexagonal to dodecagonal shape.

4. The gasoline particulate filter of claim 1, wherein a diameter of the cross section of the at least one inlet channel becomes smaller as the at least one inlet channel becomes close to the at least one flow channel.

5. The gasoline particulate filter of claim 1, wherein diameter of the cross section of the at least one outlet channel becomes bigger as the at least one outlet channel becomes far from the at least one flow channel.

6. The gasoline particulate filter of claim 1, wherein the at least one partition is formed same with cross section shape of the at least one inlet channel and the at least one outlet channel.

7. The gasoline particulate filter of claim 1, wherein a shape of the at least one inlet channel, the at least one outlet channel and the at least one flow channel is formed by using 3 dimension printing method.

8. The gasoline particulate filter of claim 1, wherein the at least one porous wall is formed by forming pores through adding organic or inorganic additives to ceramic or raw material and heat treatment.

9. The gasoline particulate filter of claim 8, wherein a size of the pores is settled by kinds of additives.

10. The gasoline particulate filter of claim 9, wherein the pores are formed as various sizes through non-uniform sedimentation of soot and ash according to location of the at least one porous wall.
